(19) United States
(12) Patent Application Publication
(10) Pub. No.: US 2011/0273323 A1
(43) Pub. Date: Nov. 10, 2011

(54) ELECTRICALLY SELF-CONTAINED RADAR DEVICE

(75) Inventors: Jean-Nicolas BAYS, Chenens (CH); Robert Bays, Villars-sur-Glane (CH)

(73) Assignee: DZOTECH SA, Chenens (CH)

(21) Appl. No.: 13/159,452

(22) Filed: Jun. 14, 2011

Related U.S. Application Data
(63) Continuation of application No. PCT/EP2009/067818, filed on Dec. 22, 2009.

(30) Foreign Application Priority Data
Dec. 23, 2008 (CH) CH2014/08

(51) Int. Cl. G01S 13/92; G01S 13/56; G01S 13/62; G01S 13/58

(52) U.S. Cl. 342/114; 342/104

(57) ABSTRACT

The invention relates to a radar device having a housing that includes: a microwave motion detection module (3) generating a Doppler signal, a signal processor (5) for calculating a speed from said Doppler signal, processing means (1) for switching the module and the signal processor from a detection mode to a speed-measuring mode and vice versa, a wireless interface (8) for transmitting said speed to a remote device, and a self-contained power supply (9) for powering the device.

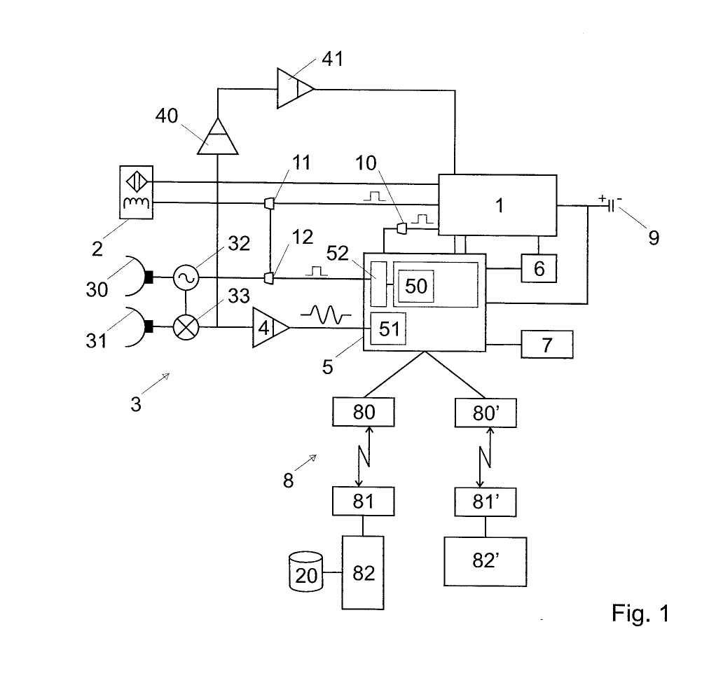

### RELATED APPLICATIONS

The present application is a continuation of the international application PCT/EP2009/067818 (WO2010/072796) filed on Dec. 22, 2009, the content of which is incorporated by reference, and which claims priority of the Swiss patent application 2008CH-02014 of Dec. 23, 2008, the content of which is incorporated by reference.

### TECHNICAL FIELD

The present invention concerns an electrically self-contained radar device.

### TECHNICAL BACKGROUND

Doppler radars used for controlling the speed of vehicles have a high power consumption, on the order of 150 milliampere or greater. Most fixed radars are thus permanently powered by the electric grid, which causes considerable connection costs. Mobile radars are often powered by an automotive battery capable of storing at least 30 ampere-hours; the autonomy however remains limited to several days and the battery's volume and weight restrict the possibilities of application.

There are also hand-held radars powered by a small-size battery; in this case, the speed measuring is triggered manually by the operator when a vehicle passes. The consumption remains high and these devices do not allow a continuous and unassisted measurement of the speed of vehicles on a section of road.

The are additionally systems for measuring the speed of vehicles that use acoustic waves instead of electromagnetic waves; these devices however do not allow a very accurate measurement of the speed of vehicles and their power consumption is also high.

FR2648905 describes a device for estimating the general behavior of a certain number of people, each person being the pilot of a moving body. The document discloses means and a method for supplying a signal by means of a sensor, for amplifying and filtering said signal to obtain a useful signal with a number of pulses that is proportional to the body's speed, for counting the number of pulses situated inside a predetermined time window, and for counting either one body if the number of pulses exceeds a displayed number, or the total number of bodies. The method further enables measurements of the speed, length, presence time in front of the sensor and inter-body time with a microcomputer to be read. The power consumption is high since the electronics always remain under voltage, even in the absence of a body.

EP0308324 concerns means for sending-receiving an electromagnetic wave and means for computing, from the Doppler frequency, the speed of a vehicle to be monitored. The device includes one or several passive sensors (for example an infrared radiation sensor or a microphone), whose reception lobe covers the send-receive beam, as well as triggering-release means of the send-receive means controlled by the sensor or sensors, for triggering the sending of the electromagnetic wave as soon as the vehicle enters in the lobe of the passive sensor and for stopping the sending of said wave as soon as the vehicle exists from said lobe. This document thus allows the radar to be reactivated when a vehicle passes in order to ensure a greater operational autonomy. Again, power consumption remains high as a great part of the electronic circuit is under voltage even when there is no vehicle in the lobe of the passive sensor.

DE-U-29709286 concerns a system for detecting vehicles, having at least one infrared sensor, a send-receive unit, a power unit with a solar cell, and a control unit. A detection unit can be constituted by a cylindrical and metallic case, closed on one side by a Fresnel optical element. Inside the case, there is a printed circuit board (PCB) with sensors and amplifiers, as well as a printed circuit for generating the signal and for a radio communication interface. Using radar sensors is also suggested as an alternative. In order to optimize the power consumption, the system can switch from a standby mode to an active mode. The control unit can force the standby mode with a radio modem.

EP0866434 and DE-U-29709286 concern a system for detecting speed and mentions a wireless transmission standard.

### BRIEF SUMMARY OF THE INVENTION

There is thus a need for a fixed radar device powered by a low-capacity and low-volume electric battery that can be used over a long period without the battery having to be replaced.

There is in particular a need for a Doppler radar device with a power consumption that is sufficiently reduced to allow speed to be measured continuously over a long period, for example a period greater than 6 or 12 months, with a low-volume battery. Advantageously, the average consumption of the device should thus be lower than 2 milliampere instead of the 150 milliampere of conventional radars.

According to the invention, these objectives are notably achieved by means of a radar device according to the characteristics of claim 1.

Using a motion detection module allows the power consumption to be reduced considerably. There are in fact modules designed to detect the movement of persons and that have remarkably low power consumption. These modules are usually used as intrusion detectors in alarm systems or to automatically switch on lamps or apparatus when a person moves closer. One of the aspects of the invention consists in using such a motion detection module, usually functioning in the X band, for an unplanned application, i.e. for detecting vehicles and measuring speed.

This detection and this speed measurement are possible by processing the Doppler signal supplied by the module with a DSP digital signal processing module for the speed measurement, notably by a Fast Fourier Transform (FFT) of the signal.

In one embodiment, the detection and speed-measuring circuit includes a low-consumption and low-frequency amplifier for detecting vehicles and an amplifier with a higher frequency and higher consumption, in combination with the DSP module, for measuring the speed.

However, as the consumption of the motion detection module and of the DSP is too great for continuous powering with a portable battery, one of the aspects of the invention consists in clearly separating the detection from the speed measurement and in using distinct elements for these two functions. According to one aspect, the vehicle detection is performed with a Doppler module powered in pulsed manner whilst the speed measurement is done with the same module but powered in continuous manner after a vehicle has been detected.

Detecting a vehicle can be used to control the powering of the speed-measuring circuit via processing means, for example a specific low-consumption hard-wired logic or microcontroller, permanently powered. The microcontroller, or the hard-wired logic, can have a highly reduced consumption and makes it possible to select, according to different parameters, the instants during which the high-frequency amplifier and/or the signal processor must be powered, as well as the cycle ratio of the Doppler module.

Radar modules operating in pulsed mode are known and used notably for detecting persons. However, classical person detection works in a frequency range on the order of several Hz to at most 100 Hz and the corresponding low-consumption amplifiers can correctly amplify the Doppler signal at these frequencies. An automotive vehicle moving at 50 km/h or even 100 km/h or more generates a Doppler frequency that is much higher, beyond the bandwidth of a low-consumption amplifier. Consequently, measuring the speed of an automotive vehicle requires an amplifier with a wide bandwidth, whose power consumption is however considerably greater.

According to a preferred embodiment, the radar module operating in pulsed mode is placed and arranged for detecting the vehicle not frontally when it is far away and quickly moves closer to or further away from the module, but when it passes next to the radar module. The cosine of the angle between the direction of the vehicle and the orientation of the radar module being at that moment much reduced, the resulting Doppler frequency at that instant is also very low. The Doppler signal generated when the vehicle passes close to the radar can thus be amplified with a first low-frequency and low-consumption amplifier and be detected for example with a simple comparator supplying a binary signal when a vehicle passes. This signal can then be used to reactivate a second high-frequency (or wide-bandwidth) amplifier and the signal-processing module, in order to measure the speed of the vehicle as it moves away from the radar module.

The device can also be programmed so as to use only the vehicle detection, in order to count the vehicles without measuring their speed, thus allowing an equivalent extension of the batteries' service life.

The device is preferably without any display for displaying the measured speed and also does not include a camera for filming or photographing the vehicles. This allows the device's consumption to be further reduced. The measured data are thus stored in a memory and transmitted remotely, if necessary, through a wireless interface, for example a ZigBee, Bluetooth, cellular or other interface.

In order to detect a passing vehicle, the device can also include a magnetometer or another sensor sending a corresponding signal to the processing means, for example to the low-consumption microcontroller. The microcontroller then sends a reactivation command to the module and/or to the signal processor in order to measure the speed of the vehicle detected by the magnetometer. The microcontroller can also be programmed to perform a classification of vehicles depending on the measured speed, the duration of the vehicle's passing close to the system, the intensity and duration of the change in the magnetic field. Depending on these parameters, the vehicle detected can be classed as light vehicle, heavy vehicle, with or without trailer, etc.

The magnetometer can also be used to count only the number of vehicles. The number counted can depend on how great the change of the magnetic field is (classification of the vehicles). This counting is independent of the speed measurement. Advantageously, the magnetometer can be powered only when a vehicle is detected, thus drastically reducing its consumption.

A two-axis or three-axis magnetometer can also be used to determine the measuring angle of the radar relative to the axis of displacement of the vehicles.

Using a radar in the X band enables the size of the antennas, and thus the volume of the device, to be limited.

### BRIEF DESCRIPTION OF THE FIGURES

Examples of embodiments of the invention are indicated in the description illustrated by the attached figure showing an electric block diagram of a radar device according to the invention.

### EXAMPLE(S) OF EMBODIMENTS OF THE INVENTION

The radar device illustrated by way of example in the figure includes processing means, for example a microcontroller 1 or another device, that can be programmed or has a hard-wired logic, with a low consumption and a reduced frequency. The microcontroller 1 is in principle powered continuously when the radar device is operational and controls the other elements of the circuit. It is also possible to use a microcontroller capable of switching by itself from a standby mode to an active mode, with a programmable cycle or depending on events detected by a low-consumption external circuit.

The microcontroller 1 receives signals from one or several external sensors, for example from a comparator 41 connected through a low-consumption amplifier 40 to the pulsed Doppler module 3, or from a magnetometer 2. These external sensors make it possible to detect passing vehicles whose speed one wishes to measure or which one wishes to count or classify. Other types of sensors capable of detecting the presence of a vehicle, including sound sensors, light barriers etc., can also be used. However, a Doppler module 3 in pulsed mode, or possibly a magnetometer, have the advantage of a very low power consumption and a reduced volume.

In one embodiment, detecting passing vehicles thus uses an external sensor including a magnetometer, for example a two-axis magnetometer detecting the external magnetic field and changes caused in this field by a vehicle. Using two axes affords the advantage of allowing a more reliable detection of the vehicles and furthermore enables the northerly direction to be determined, which can be useful in order to know the orientation of the radar device relative to the road. An optional third axis can be used to furthermore determine the inclination of the device relative to the horizontal plane and/or to measure the vertical component of the magnetic field.

The magnetometer 2 is controlled by the microcontroller 1 via a logic circuit 11, in order to perform a detection at predetermined intervals compatible with the speed and distance of the vehicles to be checked, for example every second or several times per second. In the case where the speed of automotive vehicles is to be measured, conclusive tests have been performed with a frequency of 4 to 6 Hertz.

In another embodiment, the external vehicle detection sensor uses the Doppler module 3 powered in pulsed mode, at a frequency of approximately 500 Hz, with pulses of a duration of approximately 20 μsec. In this case, a first operational amplifier 40, with low consumption and narrow bandwidth, amplifies the Doppler signal (described further below) at the output of the mixer 33. Without any vehicle, or if the distance between the vehicle and the radar module changes quickly, the Doppler signal is zero respectively lies outside the bandwidth of the amplifier 40. When a vehicle passes close to the radar, the frequency of the Doppler signal however falls within the bandwidth of the amplifier 40 that supplies a signal to the comparator 41. This amplifier thus generates a pulse transmitted to the microcontroller 1 when a vehicle passes close to the system. The microcontroller 1 then activates the processor 5 via the logic circuit 10 as well as the high-frequency amplifier 4, in order to proceed with a speed measurement.

Again, the signal at the output of the amplifier 40 and/or of the comparator 41 as well as the signal supplied by the magnetometer can be used to classify the vehicles according to their length, their speed, etc.

Other types of sensors, not illustrated, can be used, for example a sensor for detecting ambient light in order to allow an automatic switching to standby mode of the whole device, or at least of the module 3 and of the processor 5, during the night, or a clock in order to put it into standby mode and to activate it at programmable times.

The microcontroller 1 can include a counter, for example in the form of a portion of computer code, to count the number of vehicles during a given period on the basis of the signals received from the Doppler module 3 in pulsed mode, from the magnetometer 2 and/or from other sensors. This counting can be performed independently of the speed measuring and without necessarily reactivating the signal processor 5 and the high-frequency amplifier 4 at each vehicle. It is also possible to count only the vehicles of a certain class (for example lorries, light cars, etc.), with the classification being carried out on the basis of information from the Doppler module 3 in pulsed mode and/or from the magnetometer.

The radar device also includes a radar circuit with a transmission antenna 30 and a reception antenna 31. The radar circuit is preferably achieved from a motion detection module 3 based on electromagnetic waves in the X band (from 8 to 12 GHz approximately). The module further has an oscillator 32 and a mixer 33. These elements are preferably mounted in a closed case, the antennas 30 and 31 being constituted by conducting portions on a first printed circuit board (PCB) closing off one of the sides of the case. Suitable modules are for example made by the company ST Electronics Satcom & Sensor Systems, notably under the reference number HB210. The module 3 is preferably powered with a continuous voltage of 5 Volts.

The radar signal emitted by the module's transmission antenna 30 is generated by the oscillator 32 controlled by a logic circuit 12 according to the state of logic signals supplied either by the microcontroller 1 or by a second processor 5 described further below. The reflected radar signal is received by the reception antenna 31, then mixed with the signal from the oscillator with the aid of the mixer 33, so as to generate a Doppler signal at the output of the module.

This Doppler signal is then amplified by the low-consumption operational amplifier 40 and/or by the wide-bandwidth amplifier 4, when the latter is engaged in speed-measuring mode. The operational amplifier 40 is preferably powered continuously, whilst the wide-bandwidth amplifier 4, which has a high power consumption, is preferably powered only when a vehicle has been detected whose speed one wishes to measure.

The speed calculation is performed from the Doppler signal by means of a signal processor 5. The amplified Doppler signal is first converted into a digital signal by means of an analog-to-digital converter (ADC) 51 that can advantageously be integrated into the signal processor 5. The calculation of the speed can then be performed by means of conventional algorithms implementing a fast Fourier transformation by means of a FFT-module 50, for example a software module integrated in the microcontroller 5. In order to reduce consumption, this calculation of the speed is advantageously performed at a temporarily high frequency of the signal processor 5 and only when a vehicle has been detected by an external sensor, for example by a magnetometer or by the Doppler module 3 in pulsed mode, or on the basis of tests carried out by the processor 5 from the received Doppler signal, before the FFT conversion.

The vehicle's speed calculated by the processor 5 is then written into a semi-permanent memory 7, preferably in association with the time at which the measurement occurred. This time is determined by a real-time clock circuit 6, for example a quartz clock capable of supplying clock signals to the microcontroller 1 and to the signal processor 5. Other information can also be associated to the speed measurement. For example, the microcontroller 1 and/or the signal processor 5 can include a classifier, for example in the form of a portion of computer code executed by the microcontroller 1 or the processor 5 to classify the detected vehicles on the basis of the signals received by the magnetometer 2, by other sensors and/or on the basis of the Doppler signal. Thus, a heavy vehicle such as a lorry will cause a greater and longer change in the magnetic field than a small car or a two-wheeled vehicle; the amplitude of this change can thus be computed by the microcontroller 1 and/or by the signal processor 5. In the same manner, a heavy vehicle will reflect a greater portion of the emitted radar signal and, at the same speed, will modify the Doppler signal in a different manner than a smaller vehicle. On the other hand, the duration of the change in the magnetic field can be used in combination with the vehicle's speed to evaluate the length of this vehicle.

This information can be used by the radar device to determine the type of vehicle whose speed has been measured and possibly to eliminate measurements corresponding to errors or to vehicles whose speed does not need to be determined.

After these data have been computed and written into the memory 7, the signal processor 5 then returns to a vehicle detection mode, by itself or following a command from the microcontroller 1. The amplifier 4 is preferably also powered off.

The data calculated by the device can be transmitted to an optional long-distance communication module 8, for example a cellular data communication module, for example a communication card 80 of the type GSM, GPRS, EDGE or UMTS for example. This module 8 can send them to a remote server 82 provided with a corresponding receiver 81 and with a database 20. The transmission can be initiated by the radar device, for example at each passage of a vehicle, after a predetermined number of passages, at given times, or in the case of particular events (for example if a speed is detected that exceeds a threshold). In one variant embodiment, transmission is initiated by the external server that sends to the radar device commands interpreted by the microcontroller 1 and/or by the processor 5 to read-access the memory 7.

In one variant embodiment, or additionally, data computed after the passage of a vehicle can also be transmitted to a short-range communication card 80′, for example a card of the type ZigBee, Bluetooth, WLAN etc. These data can thus be sent to or be read from an external device 82′ having a compatible interface 81′. This for example allows an operator passing close to the radar device to retrieve the data stored in the memory 7. In another embodiment, the data are transmitted via this interface 80′-81′ to a display device or an indicator 82′ that is electrically self-contained, in order to display a signal or a speed indication readable by the driver of the measured vehicle.

In a variant embodiment, the reflected signal can be used, possibly after passing through a comparator, to determine the direction of displacement of a vehicle in the case of two-way roads, for example motorways, by ascertaining whether the distance between two successive pulse edges of the signal increases (the vehicle is moving away) or diminishes (the vehicle is moving closer). In this manner, the device can perform speed measurements in a single direction of displacement and eliminate from the measurement any vehicles driving in the opposite direction.

In a variant embodiment, the device can include a GPS module that can also be included in the GSM system or be made in the form of a SIM card in this module. Using two GPS devices placed at a known distance from one another enables the speed of a vehicle to be calculated with a very high precision, as the GPS allows said devices to be synchronized in a reliable manner and the instant of the measurement to be determined accurately. Furthermore, thanks to the GPS, the location of the devices is known and can be transmitted to a central unit.

In order to reduce the consumption, the price and the space requirements, the radar device preferably totally lacks a display, so that the measured speed can only be displayed or used by an external device via the interface 80 or 80′. The device is furthermore preferably without a camera or photographic apparatus, although such a device can be controlled, when a vehicle passes, by the communication module 80′ or possibly be integrated into the radar device.

All of these measures enable the power consumption of the device to be reduced considerably. In one embodiment, it can thus be powered by a disposable or rechargeable battery 9 with a limited capacity, for example a battery or a cell considerably smaller than a car battery, for example a battery or battery set of less than 150 grams affording less than 10 ampere-hours of storage.

The fact of having two distinct microprocessors 1, 5 is advantageous in order to be able to use distinct standby cycles; the signal processor 5, more power hungry, is thus on standby more often and/or more deeply than the microcontroller 1 or the corresponding processing means. Furthermore, this arrangement simplifies the remote updating of the two processors' firmware via the network interface 80 or 80′; a processor can program the other during the updating procedure.

According to one aspect, the device includes a printed circuit board (PCB) arranged as follows:
The upper part of the PCB includes the module with the two antennas 30, 31, the oscillator 32, the mixer 33, the two processors 1 and 5, the memory 7, the operational amplifiers 4, and the various associated electronic elements.
The lower part includes the communication interface 80, 80′ and its power supply.

The entire device can be integrated into a volume smaller than one liter, including the battery 9 and the antennas. This device can thus easily be hidden in an element of street furniture, a pole, etc.

The method implemented by this device will now be described.

In a preferred embodiment, the microcontroller 1 (or a hard-wired circuit) ensures the Doppler module 3 operates in pulsed mode during detection, at a frequency of approximately 500 Hz, with pulses of a length of 20 μsec, i.e. a duty-cycle of 1%. This pulsed power supply is used for vehicle detection by means of the amplifier 40. Once a vehicle has been detected, the pulsed power supply is then replaced momentarily by a continuous power supply or by another cycle ratio in order to measure the vehicle's speed.

In a variant embodiment, at regular intervals, for example 4 to 6 times per second, the microcontroller 1 sends to the magnetometer 2 a signal in order to check whether a vehicle has caused a change in the magnetic field. This step is repeated as long as no change has been detected. The microcontroller 1 can put itself into partial standby mode between two interrogations.

In another variant, the microcontroller 1 is in standby mode and is reactivated by an intelligent magnetometer, by the comparator 41, or by another sensor, when a vehicle passes. Reactivation by a magnetometer however requires the latter to be powered permanently or with a high cycle ratio that is incompatible with a very low consumption.

When the microcontroller 1 receives this information about a passing vehicle, it sends an instruction to the signal processor 5 to reactivate the latter out of its standby mode. If this information does not already come from the magnetometer, the magnetometer is reactivated from the standby mode and the signal processor first performs a series of measurements of the magnetic field by means of the magnetometer or magnetometers. Simultaneously, or as soon as the vehicle no longer causes any change in the magnetic field, the processor 5 sends a command to the oscillator 32 in order to send a radar signal in the direction of the vehicle. As indicated, the Doppler module 3 is momentarily powered continuously once a vehicle has been detected. The amplifier 4 is also reactivated at that moment from its standby mode. A speed measurement is then performed.

The signal processor 5 then performs optional tests to check whether the passing of a vehicle has been confirmed. These plausibility tests can be based on the signals supplied by the first amplifier 40, by the second amplifier 4, by the magnetometer 2, etc., and allow a preliminary check as to whether a vehicle whose speed can be determined is in fact present. It is thus possible to quickly eliminate possible false positives if the comparator 41 generates signals without any vehicle passing.

If it is confirmed that a vehicle is passing, the signal processor calculates the Fourier transform (FFT) of the received Doppler signal, in order to calculate the speed of this vehicle and/or to classify it in the manner described further above.

The result of these calculations is written into the memory 7. The signal processor 5 can also control the printed circuit board 80 in order to transmit the data to an external device 82, for example in order to display them immediately.

The device and method of the invention can be applied to the detection and speed measurement of all kinds of vehicles, objects or persons, notably of automotive vehicles, two-wheeled vehicles, skiers, etc.

1. Radar device having a housing that includes:
a microwave motion detection module generating a Doppler signal,
a signal processor for calculating a speed from said Doppler signal,
processing means for switching the module and the signal processor from a vehicle detection mode to a speed-measuring mode and vice versa,
a wireless interface for transmitting said speed to a remote device,
a self-contained power supply for powering the device.

2. The device of claim 1, said processing means including a microcontroller executing a computer program to control the detection mode and the speed-measuring mode of the signal processor and of the module.

3. The device of claim 1, including a magnetometer for detecting a change in the magnetic field caused by a vehicle arriving near the device and for sending a change-detection signal to the processing means if a change has been detected,
wherein the processing means are arranged for switching the signal processor and/or the module from the detection mode to a speed-measuring mode when they receive said change-detection signal.

4. The device of claims 1, including a first narrow-bandwidth amplifier for amplifying said Doppler signal and for generating a signal when a vehicle passes close to the device,
the processing means being arranged for switching the signal processor and/or the module from the detection mode to a speed-measuring mode when they receive said signal.

5. The device of claim 4, including a second amplifier with a bandwidth wider than that of the first amplifier for amplifying said Doppler signal,
said second amplifier being powered only when a vehicle has been detected by means of the first amplifier so as to allow the speed of said vehicle to be measured.

6. The device of claim 5, wherein the bandwidth of the first amplifier allows a vehicle to be detected when it passes close to the device, and wherein the bandwidth of the second amplifier allows the speed of the vehicle to be measured after it has been detected and while it is moving away from the device.

7. The device of claims 3, including a counter for counting the number of vehicles detected.

8. The device of claim 3, including a classifier for classifying the vehicles according to their length determined by taking into account the signals at the output of the magnetometer respectively of the first amplifier and/or of the second amplifier.

9. The device of claim 3, wherein the microcontroller includes a computer programs to interrogate periodically the magnetometer in order to check whether a vehicle is present.

10. The device of claim 3, wherein the magnetometer is powered only when a vehicle has been detected.

11. The device of claim 2, including a semi-permanent memory for storing said speed,
wherein the signal processor controls said semi-permanent memory and said wireless interface in order to allow said speed to be transmitted.

12. Speed-measuring method by means of an electrically self-contained radar device, including:
use of a microwave motion detection module in order to generate a Doppler signal,
calculating a speed from said Doppler signal, by using a signal processor,
switching the module and/or the signal processor from a vehicle detection mode to a speed-measuring mode and vice versa, on the basis of the signals supplied by the processing means,
transmission of said speed to a remote device with a wireless interface.

13. The method of claim 12, wherein said processing means include a microcontroller for switching said module to speed-measuring mode according to the signals received by a magnetometer.

14. The method of claim 12, wherein a first narrow-bandwidth amplifier amplifies said Doppler signal and generates a signal when a vehicle passes close to the device,
wherein the signal processor and/or the module switches from a detection mode to a speed-measuring mode following the generation of said signal.

15. The method of claim 14, wherein a second amplifier with a bandwidth wider than that of the first amplifier amplifies said Doppler signal in order to allow the speed of the vehicle to be measured,
wherein said second amplifier is powered only once a vehicle has been detected by means of the first amplifier.

16. The method of claim 15, wherein the vehicle is detected by means of the first amplifier when it passes close to the device and wherein the speed of the vehicle is determined by means of the second amplifier when it moves away from the device.

17. The method of claim 15, including a step of classifying the vehicles according to their length evaluated from the signals supplied by the magnetometer respectively by the first amplifier and/or the second amplifier.
